(19) United States
(12) Patent Application Publication
(10) Pub. No.: US 2003/0137673 A1
(43) Pub. Date: Jul. 24, 2003

(54) Systems, and methods of use, employing distorted patterns to ascertain the shape of a surface, for road or runway profiling, or as input to control pro-active suspension systems

(76) Inventors: Cary B. Cox, Hinds, MS (US); Lewis B. Smithhart, Utica, MS (US); Barry W. McCleave, Vicksburg, MS (US); Charles R. Welch, Vicksburg, MS (US)

Correspondence Address: HUMPHREYS ENGINEER CENTER SUPPORT ACTIVITY, ATTN: CEHEC-OC, 7701 TELEGRAPH ROAD, ALEXANDRIA, VA, 22315-3860, US

(21) Appl. No.: 10/318,214

(22) Filed: Dec. 13, 2002

(51) Int. Cl. G01B 11/24

(52) U.S. Cl. 356/601; 356/604

(57) ABSTRACT

Provided in a preferred embodiment is an application of phase or “shadow” profilometry to determine a 3-D profile of structure instantaneously. In one application, a vehicle-mounted system captures a 3-D profile while operating normally. The system may use a digital camera, a computer for processing and storage, a broadband light source, and a device positioned between the light and structure that enables strips of light to impinge on the structure. A preferred embodiment uses a single straight edge as the device, casting a straight line shadow. In addition to profiling road surfaces, the bottom of hydraulic models have been profiled even while being disturbed with a wave generator. It may be integrated with other devices such as a pro-active suspension system for civilian, military, and construction vehicles. Further, use with tiltmeters and GPS receivers provides data useful for engineering or construction management.

### STATEMENT OF GOVERNMENT INTEREST

The invention described herein may be manufactured and used by or for the Government of the United States of America for governmental purposes without the payment of any royalties thereon or therefor.

### FIELD OF THE INVENTION

This invention relates to systems and methods of establishing a three-dimensional profile of structure concurrently while moving over it. Specifically, a 3-D profile is deduced via a system onboard a transporter that manipulates specially acquired inputs from a single means, such as a digital camera that conventionally provides two dimensions only.

### BACKGROUND

The Army Future Combat System will travel at high speeds over rough roads. This type of driving increases the vibration experienced by both passengers and cargo while challenging a vehicle's suspension to maintain good traction. Pro-active suspension systems provide a solution to address these concerns. Implementation of such a system is permitted if a sensor may “read” the road surface ahead of the vehicle and provide input to adjust the suspension accordingly. Although these are military goals, a pro-active suspension system would be beneficial for commercial and recreational applications also. There are other applications in addition to the pro-active suspension.

For the military engineer, maintaining roads in remote areas is an ongoing challenge. Conventional methods schedule road maintenance based on engineering rules of thumb and visual observations. A system that could accurately profile a road surface by input from data collected using non-contact means by vehicles traveling over the surface would provide better and more timely data for scheduling. As well, it would provide an objective measure of those construction and maintenance methods that have provided the best solution to specific conditions, such as topography, weather, and type and amount of traffic. Again, both commercial and government organizations would benefit from having this type of information available for roads under their cognizance. Further, evaluation of construction or repairs made under contract could be made objectively for purposes of quantifying contract performance.

Conventional road-profiling systems use:

“contact” means, i.e., they make physical contact with the surface;

coherent light, i.e., they illuminate the surface with one or more lasers;

multiple standard video systems;

multiple transducers or sensors mounted beneath a vehicle; or

pulsed non-optical energy, such as sound.

A most recent example of systems employing contact means is found in U.S. Pat. No. 6,161,429, Dual Path Profilograph, to Marvel et al., Dec. 19, 2000. The system provides two parallel spaced beams linked to a transporter such as a trailer to be towed by a vehicle. Each beam has a profiling wheel(s) for measuring surface deviations, the measurements being transmitted to a recorder.

A vehicle-mounted laser is employed to provide a map of irregular or contoured portions of a road surface as detailed in U.S. Pat. No. 4,896,964, System for Measuring Irregularities of Road Surface, to Kitazume, Jan. 30, 1990.

An example of systems employing multiple video systems include U.S. Pat. No. 4,899,296, Pavement Distress Survey System, to Khattak, Feb. 6, 1990 in which two video cameras, mounted at acute angles with respect to each other and providing overlapping coverage, are aimed from the front of a vehicle to the pavement. Data collected may consist of infrared as well as visible light and the cameras are used with an onboard analysis system to determine condition of the pavement.

U.S. Pat. No. 4,741,207, Method and System for Measurement of Road Profile, to Spangler, May 3, 1988, provides multiple transducers mounted on a vehicle to measure road surface irregularities while correcting for vehicle acceleration in the direction of slope and surface slope at fixed increments of vehicle movement.

An example of a combination, laser and pulsed non-optical system is found in U.S. Pat. No. 5,440,923, Drivable Slope-Sensitive Unit for Measuring Curvature and Crossfall of Ground Surfaces, to Arnberg et al., Aug. 15, 1995. It employs a number of separate devices that feed data to an analyzer, including: two separate inclinometers, an angular velocity gyroscope, and a pulsed system for measuring various accelerations experienced by the vehicle on which it is mounted.

A number of ultrasound transducers affixed to a trailer towed behind a vehicle, pulse the road surface and record responses therefrom as described in U.S. Pat. No. 5,280,719, Measurement of Road Roughness, to Per, Jan. 24, 1994.

Alternative embodiments suitable for profiling may use complex processing systems implementing Fourier Transform Profiling (FTP), filtering of high order harmonics to facilitate precise measurement, use of pulsed light through a slit, and multiple light sources or multiple CCDs to facilitate high-speed processing.

An example of a system for determining a 3-D profile of a surface using FTP is found in U.S. Pat. No. 4,641,972, Method and Apparatus for Surface Profilometry, to Halioua et al., Feb. 10, 1987. It involves either a laser to generate interference fringes or an illuminator projecting a phase-modulated sinusoidally varying pattern spatially and complex processing algorithms, especially when using non-coherent light as the illumination. This simulates temporal sinusoidal intensity variation. The disadvantage of using the laser is that the interference pattern is vulnerable to turbulence, vibration, and defects in optics. It also must contend with laser speckle noise. The disadvantage of using the non-coherent system is that a sinusoidal grating with high contrast and accurate waveform is difficult to generate and commercial systems have poor contrast resulting in poor signal-to-noise ratio. While extolling the virtues of FTP, the inventors also express its limitations:

Limitations on measurement of steep object slopes and step discontinuities, the need for high resolution imaging systems and the need for powerful computing capability are some of the disadvantages of the Fast Fourier Transform method.

The advances in both optics and computing power since the mid-eighties, with attendant reduction in cost of systems incorporating these advances, has obviated the most significant of these disadvantages. Further, if one wishes to determine a relative condition of a surface, then the measurement of steep object slopes and step discontinuities is of minor concern, especially if data may be taken at high rates such that very small increments of a surface are sampled.

A newer system employing an amplitude modulated laser and related processing optics is described in U.S. Pat. No. 6,002,423, Three-Dimensional Imaging System, to Rappaport et al., Dec. 14, 1999. It provides real time 3-D images without the need for expensive stereoscopic equipment.

U.S. Pat. No. 5,280,542, XYZ Coordinates Measuring System, to Osamu et al., Jan. 18, 1994, uses pulsed light of adjustable intensity synchronized to a receiving TV camera and directed through a slit to measure the surface of a shape that is known a priori. The system images the reflection from the slit line on the surface with the TV camera to obtain precise 3-D coordinates of a surface that may be moving at high speed and may have significant changes in reflectivity on its surface. The relation of the slit line to the 3-D coordinates of the surface is stored in a lookup table. Data read from the look-up table is synchronized with the pulsed light.

In addition to the above methods of profiling, certain patents are directed to very precise measurements of a surface such as U.S. Pat. No. 6,040,910, Optical Phase Shift Triangulation (PST) for Non-Contact Surface Profiling, to Wu et al., Mar. 21, 2000. This device projects a varying intensity pattern onto the surface while filtering it to attenuate high order harmonics. The pattern is spatially shifted more than twice to provide an accurate representation of the surface.

There is an advantage to performing profiling without the use of moving parts and while moving at high speed, e.g., to permit real time or near real time profiling as detailed in U.S. Pat. No. 6,268,923 B1, Optical Method and System for Measuring Three-Dimensional Surface Topography of an Object Having a Surface Contour, to Michniewicz et al., Jul. 31, 2001. It uses a triple CCD optical interferometer to provide and simultaneously collect three images, each with a unique phase but a known fringe pattern that is optically introduced to each image.

An alternative system to using multiple CCDs is to employ multiple illumination sources as described in U.S. Pat. No. 6,122,062, 3-D Camera, to Bleman et al., Sep. 19, 2000. A matrix of lights, such as LEDs, provides different shading patterns on the surface depending upon which row of lights in the matrix is lit.

The Army also conducts extensive modeling of harbors and channels in which the profile of the bottom of the model is painstakingly measured to document effects of wave action thereon. The topology of a sandy bottom in a hydraulic model and any migration mechanism during a hydraulic test is of great interest to investigators. Conventional methods of measuring migration involve draining water from the model and manually taking measurements. Of course, during the test, bottom topography may be determined by probing the model, however this is both time consuming and expensive. It would be beneficial to have a system that could perform this task using methods requiring much less manpower, such as an application of “shadow” profilometry of the present invention. A shadow need not be cast by light to be considered a shadow. Witness the use of side-looking radar to “image” objects on the ground. Shadow profilometry utilizes a matrix of data points distributed over a surface rather than a set of isolated points while giving investigators the ability to measure bottom topology through the water's surface, including those periods when wave action is present.

Systems used for underwater profiling have an additional element to consider, the turbidity of the medium. U.S. Pat. No. 5,467,122, Underwater Imaging in Real Time, Using Substantially Direct Depth-to-Display-Height LIDAR Streak Mapping, to Bowker et al., Nov. 14, 1995 describes a complex airborne system using active blue-green fan-shaped laser pulsed beams to image undersea objects by reflection therefrom. This system suffers from its complexity and its costs.

What is needed is a simple, robust, inexpensive system able to profile a surface from a vehicle operating at its normal speed. In one embodiment, it should be capable of providing useful profile data in near real time, e.g., sufficiently responsive to permit an onboard pro-active suspension to react to road surface changes. It may be capable of passive operation, i.e., it emits no energy. Although a certain precision of measurement is desirable, a useful embodiment may provide a simple relative measure of changes in surface profile. Specific embodiments of the present invention provide solutions to these needs.

Phase profilometry, a descriptive term that aptly describes the mathematical manipulations undertaken to acquire a 3-D representation, provides a method for capturing in “near real time” a three-dimensional (3-D) representation of structure by analyzing distortions in reflections from the structure. Work in this area using a Fourier Transform is described in the article by Mitsuo Takeda and Kazuhiro Mutoh, Fourier Transform Profilometry for the Automatic Measurement of 3-D Object Shapes, Applied Optics, Vol. 22, No. 24, 15 December 1983. One of the advantages of using the Fourier Transform or Fast Fourier Transform (FFT) in conjunction with profilometry, i.e., Fourier Transform Profilometry (FTP), lies in the ease of computer processing of the resultant transformation for subsequent use. Prior to this discovery, scientists were using methods than provided a moiré analyses suitable for use by human observers rather than for computer processing. Further, FTP, or phase profilometry, provides much higher sensitivity than conventional moiré techniques, detecting variations much less than one contour fringe in moiré topography. A specific application of FTP used in a preferred embodiment of the present invention uses the shadow cast by a simple straight edge to develop a profile of the instantaneous contour, thus it is termed “shadow profilometry.”

Distortion includes that produced by “contrasts” resultant from projections of electromagnetic energy, e.g., shadows induced by light (or other electromagnetic energy) projected onto an irregular or contoured surface. Subsequent processing after collection of suitable reflections of this energy, to include an FFT conversion of digital data and implementation of a simple algorithm, provides the “third dimension” absent in a conventional analog or digital representation of the surface. Further, a suite of simple commercial-off-the-shelf (COTS) hardware may permit determination of a 3-D profile as one proceeds over the roadway.

Conventional phase profilometry capitalizes on the distortion introduced by periodic contrasts, such as shadows induced by light impinging a grid. In one embodiment, phase profilometry is enabled through the use of broadband light that illuminates an irregular or contoured surface. Reflections from this surface are viewed by an observer or a collector off-axis from the source of illumination as distorted contrasts, i.e., conventional shadows if the impinging energy is light. Alternatives to simply projecting broadband light include projecting monochromatic light or projecting broadband light through suitable means to have images impinge upon a targeted surface. Images may include one or more simple bands, or bars, of light as directed through a slit or grid.

analyzing distortions in reflections from the structure. Work in this area using a Fourier Transform is described in the article by Mitsuo Takeda and Kazuhiro Mutoh, Fourier Transform Profilometry for the Automatic Measurement of 3-D Object Shapes, Applied Optics, Vol. 22, No. 24, 15 December 1983. One of the advantages of using the Fourier Transform or Fast Fourier Transform (FFT) in conjunction with profilometry, i.e., Fourier Transform Profilometry (FTP), lies in the ease of computer processing of the resultant transformation for subsequent use. Prior to this discovery, scientists were using methods than provided a moiré analyses suitable for use by human observers rather than for computer processing. Further, FTP, or phase profilometry, provides much higher sensitivity that conventional moiré techniques, detecting variations much less than one contour fringe in moiré topography. A specific application of FTP used in a preferred embodiment of the present invention uses the shadow cast by a simple straight edge to develop a profile of the instantaneous contour, thus it is termed “shadow profilometry.”

Distortion includes that produced by “contrasts” resultant from projections of electromagnetic energy, e.g., shadows induced by light (or other electromagnetic energy) projected onto an irregular or contoured surface. Subsequent processing after collection of suitable reflections of this energy, to include an FFT conversion of digital data and implementation of a simple algorithm, provides the “third dimension” absent in a conventional analog or digital representation of the surface. Further, a suite of simple commercial-off-the-shelf (COTS) hardware may permit determination of a 3-D profile as one proceeds over the roadway.

Conventional phase profilometry capitalizes on the distortion introduced by periodic contrasts, such as shadows induced by light impinging a grid. In one embodiment, phase profilometry is enabled through the use of broadband light that illuminates an irregular or contoured surface. Reflections from this surface are viewed by an observer or a collector off-axis from the source of illumination as distorted contrasts, i.e., conventional shadows if the impinging energy is light. Alternatives to simply projecting broadband light include projecting monochromatic light or projecting broadband light through suitable means to have images impinge upon a targeted surface. Images may include one or more simple bands, or bars, of light as directed through a slit or grid.

### SUMMARY

Provided is a method and necessary apparatus for deducing in near real time a third dimension of structure. It uses a collector positioned off-axis from a source of electromagnetic energy directed at the surface of the structure.

A simple hardware setup may be used to implement phase profilometry as used in a preferred embodiment of the present invention. For example, data collection may be provided via a camera, preferably a digital camera. Illumination of the structure to be profiled may be by a simple non-coherent light source such as a conventional slide projector, or even by re-directing a natural source of light such as the sun or moon, through a slit or grid. Additional equipment, including COTS devices, may be used to automate the collection and subsequent analyses.

The method involves:

establishing at least one contrasting portion on the surface by utilizing projection of electromagnetic energy from the source and at least one device to modulate the projections;

in its simplest form, moving the device over the surface of the structure in one direction at a time, thus producing a distorted portion of reflected electromagnetic energy from the surface wherever the surface is not flat in a plane parallel to the direction of movement of the device;

using at least one collector, such as a camera, off-axis from the source, for receiving reflections from the surface; and

using a pre-specified algorithm, processing the reflections including those that are distorted by vertical variations in the surface.

The source may provide electromagnetic energy that operates within wavelengths incorporating any of: radar frequencies, radio frequencies (RF), non-coherent visible light, non-coherent infrared (IR) light, non-coherent ultraviolet (UV) light, coherent visible light, coherent infrared (IR) light, coherent ultraviolet (UV) light, and any combination thereof. The contrasting portion may be a shadow, the edge of which is used by the pre-specified algorithm to compare to images of the surface that are not distorted thus yielding height information. In one embodiment the camera used is a digital camera.

The device may be a simple construct that directs light or other electromagnetic energy so that one or more strips of energy impinge on the surface of interest. Each strip may be longer in one dimension than its other dimension as described by its image on the surface. The strip of energy may be projected so as to be either parallel or non-parallel to the direction of movement of the device as it is “imaged” on the surface of interest.

The processing may entail:

converting collected analog data to digital format;

doing a Fast Fourier Transform (FFT) of these reflections to yield FFT data;

filtering the resultant FFT data about the fundamental spectral frequency of the projected electromagnetic energy in the direction transverse to the direction of movement of the device; and

employing complex algorithms to extract the change in phase of the electromagnetic energy; and

using the results from the complex algorithms to construct a vertical profile to complete the 3-D representation.

Some practical uses of near real time phase profilometry include inputting data to pro-active suspension systems, profiling road surfaces, dynamic profiling of bottom surfaces in harbors or channels, measuring high-speed dynamic deflection of walls, and measuring craters in sand and concrete. For example, using laboratory equipment, the technique of phase profilometry has been used to measure time-dependent surface topography of waves generated in a large scale hydraulic model of a harbor. Cox, C. et al., Measurement of Wave Field Histories in Hydraulic Models Using Phase Profilometry, 6^{th} International Workshop on Wave Hindcasting and Forecasting, Monterey, Calif., Nov. 6-10, 2000. Cox, C. et al., Phase Profilometry Measurement of Wave Field Histories, 4^{th} International Symposium on Ocean Wave Measurement and Analysis, San Francisco, Calif., Sep. 2-6, 2001.

In the above examples, the collection equipment configuration that facilitated the creation of 3-D profiles comprised a simple digital camera and a slide projector that projected a grid such as the well known periodic Ronchi pattern. A periodic pattern is not required to achieve desired results using a preferred embodiment of the present invention. For example, a single simple shadow of a straight edge, e.g., a visible line shadow, cast by the vehicle transporting the system may suffice to provide the distortion needed for comparison to an undistorted two-dimensional (2-D) view of the surface. Using the edge of this shadow provides the necessary contrast (as well as distortion) for use in phase profilometry. This edge is essentially a 2-D line that is simple to process. In all cases, a 3-D profile is deduced by taking the distorted patterns, e.g., visible shadows in the case of visible light projection, and interrelating these with the undistorted patterns such as that provided by direct on-axis views of the surface by a camera, or those had by theoretical modeling to predict the undistorted shadows. Coupling the above simple collection devices with inexpensive powerful digital signal processors and personal computers providing considerable data storage enables a robust portable package suitable for use in military, recreation or construction operations.

Advantages of a specific embodiment of the present invention include:

inexpensive hardware and software to implement;

simple to operate, lending itself to semi-autonomous operation when collecting data for analysis and autonomous operation when used with a pro-active suspension system;

readily upgradeable to take advantage of advancing technology and lower device costs;

available as a robust installation for military, construction and recreational uses;

easily maintained;

adaptable to multiple applications;

inherently safe since a preferred embodiment need not use laser light or high power electrical systems;

inherently accurate; and

useful as a management tool as well as a testing device.

### BRIEF DESCRIPTION OF THE DRAWINGS

FIG. 1A is a schematic diagram of elements that may be used in a preferred embodiment of the present invention.

FIG. 1B provides a geometric representation that is used to describe the theory developed for implementation of a preferred embodiment of the present invention.

FIG. 2 is a pictorial representation of the steps used in implementing a preferred embodiment of the present invention.

FIG. 3 compares data taken using a preferred embodiment of the present invention with that taken using manual measurements.

FIG. 4 compares data taken using a preferred embodiment of the present invention with that taken using a laser system.

FIG. 5 compares data taken using a preferred embodiment of the present invention with that taken using manual measurements for both the x-axis and y-axis orientation.

FIG. 6 is a block diagram of a system representing a preferred embodiment of the present invention.

FIG. 7 depicts a comparison of the surface as distorted by a preferred embodiment of the present invention with the mathematically derived 3-D representation that was collected while employed on a vehicle normally operating on a road.

FIG. 8A depicts a mathematically derived topographic representation of sand on the bottom of a hydraulic model through a static water surface.

FIG. 8B depicts a mathematically derived topographic representation of sand on the bottom of a hydraulic model through a dynamic water surface subjected to a wave generator.

### DETAILED DESCRIPTION

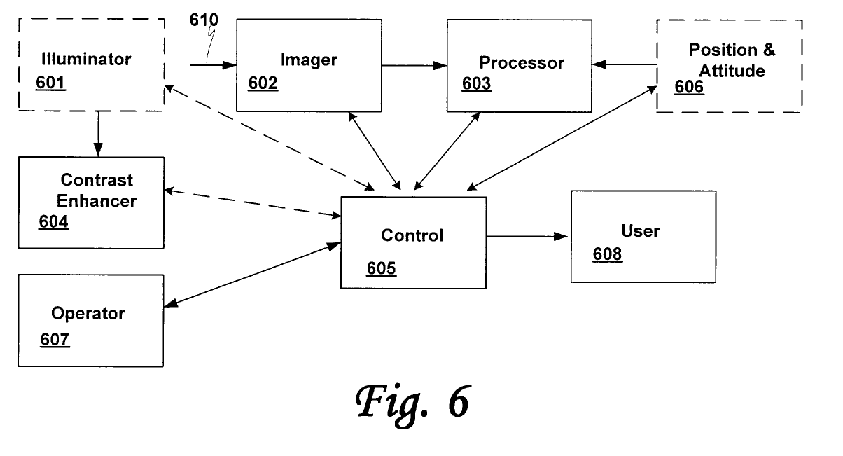

Refer to FIG. 6. A preferred embodiment of the present invention capitalizes on positioning an object, hereafter referred to as a contrast enhancer 604, between an active energy source, hereafter illuminator 601, and a contoured or irregular surface to be profiled while collecting reflected energy 610 from the surface with an imager 602. The illuminator 601 may be a manmade device or a natural source such as the sun, moon, or reflections therefrom. The reflected energy 610 may reside in any frequency or combination of frequencies within the electromagnetic spectrum to include ultraviolet, infrared, visible light, radar, or radio frequencies (RF). The contrast enhancer 604 distorts energy emitted from the energy source that would otherwise project unimpeded onto the surface of interest. The contrast enhancer 604 may be a separate device able to be controlled by the control 605 or part of an existing apparatus appropriately positioned in advance of image collection. In a preferred embodiment, the collected energy 610 is processed by a processor 603 that is controlled by a control 605 that is operated by an operator 607. The collected energy may be processed in near real time to yield a 3-D profile of the surface for output from the control 605 to a user 608. The user 608 may be another system such as a proactive suspension on a vehicle, an engineer charged with maintenance of a road, or a contract manager charged with evaluating performance on a road maintenance contract. The surface of interest may be directly under or in front of and below a vehicle. The contrast enhancer 604 may be a vehicle itself or an attachment thereon. Finally, in certain applications, such as road profiling over long stretches, it is advantageous to know vehicle position and attitude so that devices that determine position and attitude 606 may be provided as an option.

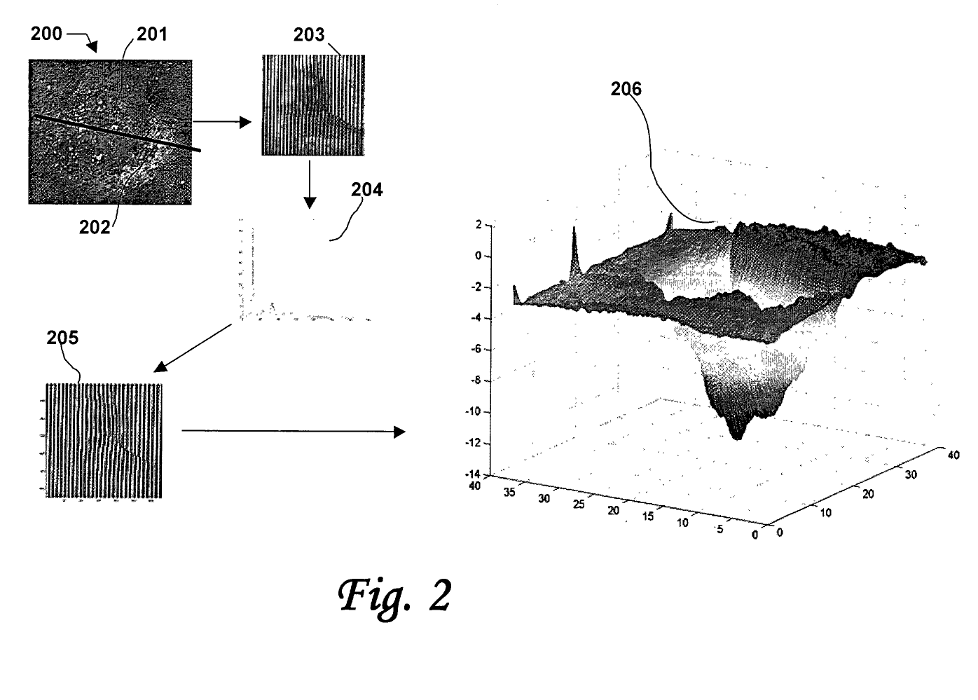

Phase profilometry uses periodic shadows from visible light falling onto a surface to measure that surface's topography. Refer to FIG. 2. An example of a periodic shadow is the shadow cast by a common window blind. An observer, not on-line with the light source and shadow, sees a modulation of the shadows caused by changes in surface elevation. The change in phase between the modulated and unmodulated shadow patterns can be used to calculate the surface elevation.

The change in phase, Δθ, is related to changes in the vertical dimension of the structure, z, by the relationship:

$$z ( x , y ) = \frac{L \cdot Δ θ}{Δ θ - 2 π \cdot f \cdot d} \qquad ( 1 )$$

where:

f=frequency of the electromagnetic energy

d=horizontal distance between the collector and the source when the surface to be profiled is horizontal and parallel to the plane in which the collector and source are located

L=distance between the collector and the surface

After processing a single frame of the reflections, an ordered triplet, (x, y, z), is established that may be archived for future analysis. Multiple such ordered triplets may be displayed as mesh plots or contour plots, as desired.

Unlike conventional applications of phase profilometry, in a preferred embodiment of the present invention, energy of different characteristics than ambient energy may be directed to and reflected from a surface of interest without need for the energy to exhibit periodicity.

Similar to a scanning laser beam, a preferred embodiment of the present invention provides a profile of an area rather than that of a point or a line. Unlike a laser system, it has no moving parts, although its orientation may be adjusted to optimize coverage. Further, the possibility of using non-coherent light sources eliminates a safety hazard inherent in laser usage.

Takeda and Mutoh (1983) present a method for deriving surface profiles using periodic shadows cast onto a surface which they called “Fourier Transform Profilometry,” and is the method adapted, not copied, for use in a preferred embodiment of the present invention. In this method each line of the image (y) is analyzed separately. If a line (x) perpendicular to Ronchi grating lines of the non-deformed grid is viewed as a space versus amplitude (light intensity) plot, it would appear as square-wave. Analytically this line can be described by:

$$g ( x , y ) = {\sum }_{n = - ∞}^{∞} {A}_{n} {ⅇ}^{j [ 2 π \cdot {f}_{n} \cdot x + {θ}_{n} ( x , y ) ]} \qquad ( 2 )$$

where:

j=(−1)^{1/2}

f=frequency, and

θ=phase angle

If a surface is illuminated by a Ronchi grid, a deformed grid will result. When each line of a deformed grid is filtered and multiplied by the complex conjugate of the corresponding line in the reference plane, the result is:

g_{filtered}(x,y)·g′_{REF(filtered)}(x,y)=|A₀|²r(x,y)·e^{jΔφ(x,y)} (3)

where:

g′_{REF(filtered)}(x,y)=the complex conjugate of g_{REF(filtered)}(x, y)

Δφ(x, y)=φ₀(x, y)−φ₀(x, y), i.e., the change in phase caused by the change in elevation of the surface.

Taking the log of this product yields:

log [|A₀|²r(x,y)]+jΔφ(x,y) (4)

The imaginary part yields the change in phase, Δφ(x, y).

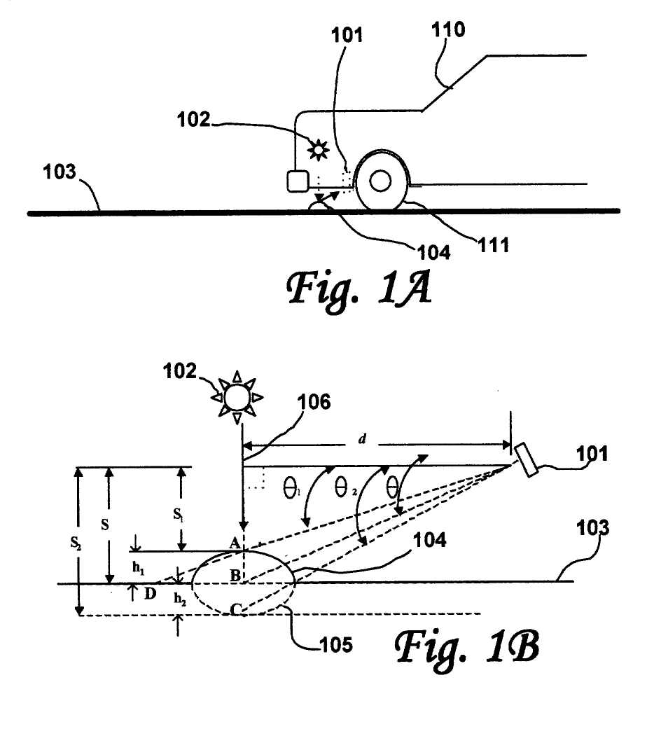

Refer to FIG. 1A. The imager 101 and light source 102 are separated from each other by a distance d. They are located a distance S from the road surface 103 (background reference plane), and a grid of f₀ cycles per unit distance is projected onto the background. In a preferred embodiment of the present invention, the “grid” is a single straight line. To understand the 3-D measurements, consider the example of one pixel when there is no object in the picture. Light, modulated by a grid such as a Ronchi grid (not separately shown), travels from the light source 102 to point B on the road surface 103 and is then recorded by the imager 101.

When a contour or irregularity 104, 105 appears along the road surface 103, the light strikes the irregularity at location A or C. When the 2-D imager 101 views this change as a bump 104 in the road surface 103, it appears that the grid has moved to point D. The relationship between the distance, BD, and the change in phase of the grid (Δφ) from its reference plane (road surface 103) value at this point is given by:

Δφ=−2π·BD·f₀ (5)

The object of these measurements is to obtain h₁ (or h₂ for a pothole), the height at each pixel on the image. Notice that the triangle formed by the imager 101, the light source 102 and A, and the triangle formed by B, D, and A, are similar triangles. The heights of these triangles are then proportional to the sides d and line BD, as shown in the formula:

$$\frac{d}{BD} = \frac{S - {h}_{1}}{{h}_{1}} \qquad ( 6 )$$

By substituting the calculated value of line BD and solving for h₁, we obtain the profilometry formula:

$${h}_{1} = \frac{S \cdot Δ φ}{Δ φ - 2 π \cdot d \cdot {f}_{0}} \qquad ( 7 )$$

This formula is the same as Eqn. 1, substituting h₁ for z(x, y) and S for L, and relates the phase of each pixel to the geometry of the profilometry configuration so that the third dimension, i.e., distance h₁ or h₂, may be calculated. When this type of profilometry is used, the deformed grid and the image are separated from each other so that the phase of the grid may be measured and used to calculate the depth at each pixel of the image. Additionally, intra- and inter-frame geometrical line tracking may be used to eliminate the 2π phase jump problem. It can be seen from Eqn. (7) that the error in h₁, h₂ will vary linearly with S. Errors in f₀ or d also generate errors in h₁, h₂, but not linearly. It is important to know these parameters as exactly as possible. The major contributor to error is the measurement of the phase change, Δφ.

Refer to FIG. 2. A pothole 201 is shown as a portion of a road surface 200 to be profiled. The line of reference along the road surface 200 is shown at 202. A Ronchi grid is used to establish the necessary distortion in the image as depicted at 203. A Fourier Transform as depicted at 204 is taken of the resultant phase comparison of the distorted image and an undistorted image. The inverse Fourier Transform, as depicted at 205, is then taken of the comparison. The result may be stored for further processing or archiving, used as input to another system such as a proactive suspension, or displayed in a mathematical 3-D representation as at 206.

The phase profilometry calculations of Eqn. (1) require a complex signal, e^{jw(θ)t}, but the Ronchi grating lines provide only the real component of the signal, cos [ω(θ)t]. When working with a finite data segment from t=0 to T, the Fourier Transform of a complex signal is given by:

$$X ( w ) = {\int }_{- ∞}^{∞} [ u ( t ) - u ( t - T ) \cdot [ {ⅇ}^{j ω ( θ ) t} \cdot {ⅇ}^{- j ω t} ] ⅆ t \\ X ( w ) = \frac{sin [ ω ( θ ) - ω ] T}{[ ω ( θ ) - ω ]} - j cos [ ω ( θ ) - ω ] \frac{T}{[ ω ( θ ) - ω} + j \frac{1}{[ ω ( θ ) - ω ]} \qquad ( 8 )$$

where u(t) is the step function. Letting cos [ω(θ)t] represent the signal and taking the Fourier Transform of the finite segment yields:

$${X}^{′} ( ω ) = {\int }_{- ∞}^{∞} [ u ( t ) - u ( t - T ) ] \cdot [ cos ( ( θ ) t ) \cdot {ⅇ}^{- j ω t} ] ⅆ t \\ X ( ω ) = \frac{1}{2} ( \frac{sin [ ω ( θ ) - ω ] T}{[ ω ( θ ) - ω ]} - j cos [ ω ( θ ) - ω ] \frac{T}{[ ω ( θ ) - ω ]} + \\ j \frac{1}{[ ω ( θ ) - ω ]} ) + \frac{1}{2} ( \frac{sin [ ω ( θ ) - ω ) T}{[ ω ( θ ) + ω ]} + \\ j cos [ w ( 0 ) + w ] \frac{T}{[ ω ( θ ) + ω ]} - j \frac{1}{[ ω ( θ ) + ω ]} ) \qquad ( 9 )$$

The first term of X′(ω) is equal to ½X(ω). Taking the Inverse Fourier Transform will yield the complex sequence needed for profilometry calculations. The difference between 2X′(ω) and X(ω) is the error incurred by using this method to compute the complex term, e^{jω(θ)t}, such that:

$$ERROR = \frac{sin [ ω ( θ ) + ω ] T}{[ ω ( θ ) + ω ]} + j cos [ ω ( θ ) + ω ] \frac{T}{[ ω ( θ ) + ω ]} - j \frac{1}{[ ω ( θ ) + ω ]} \qquad ( 10 )$$

This error for positive values of ω will decrease as the length of the line T increases. The error will also decrease as ω(θ) increases. This error is the minimum error that can be expected when the Fourier Transform is used in phase profilometry processing.

While a known grid pattern, such as the Ronchi grid, is beneficial to use, a general case may include any shadow impinging on the surface. The height: shadow relationships may be complicated or simple and may be determined analytically or experimentally. Further, the contrast may be provided by illumination that causes but a single simple shadow, e.g., a slit of interrupted light falling as a shadow onto the road surface. Digital imagers may be used to record the distorted shape of the projected image that is translated into the third, or height, dimension. Although digital imagers, storage devices, and processors are preferred for ease of processing, analog imagers, analog storage devices, analog processors, or any combination thereof may be used alone or in combination with digital imagers, storage devices, and processors. With the availability of inexpensive reliable hardware and software, the additional computational complexity no longer presents the barrier it once did.

The source of energy may be a broadband source, e.g., light that may be natural, such as that from the sun or moon, or artificial, such as that from an incandescent bulb. While a satisfactory, simple, yet robust system may be implemented using broadband visible light to cast the shadow, monochromatic and coherent (laser) light sources may also be used. In addition to light in the visible spectrum, it may be advantageous to use either UV or IR light to attain specific goals, e.g., use of IR wavelengths would enable the system to penetrate vegetation that may be covering the surface of interest and use of UV light would enable more precise measurements to be made.

In a preferred embodiment, a shadow-based road profiling system comprises:

a light source;

a contrast enhancer in front of the light source, e.g., a grid such that a shadow is cast on the road surface, or an apparatus having a slit through which light passes such that a strip of light contrasting with ambient light is projected on the surface;

an imager such as a digital camera; and

a processor that receives input from the imager, compares a distorted image to an undistorted image, and may output to a storage device, a display, an input to a second system such as a pro-active suspension, or any combination thereof.

### EXAMPLE I

Refer to FIG. 1A in which a straightforward embodiment of a road surface profiler is depicted mounted on the front of a vehicle 110. An imager 101, such as a digital camera, is affixed on the front of the vehicle 110 along with a light source 102, such as a planar or telecentric light, that is mounted in a location separate from the light source 102. The light source 102 may illuminate the entire width in front of the vehicle 110 or may be two separate light sources (not separately shown), one in front of each tire 111 for use with a “pro-active” suspension system (not separately shown). The light source 102 is shown illuminating a “positive” irregularity, i.e., a bump 104, in the road surface 103.

Refer to FIG. 1B depicting the geometric relationships between some of the elements of FIG. 1A. A straight line shadow 106 is cast using a telecentric light source 102. A digital imager 101 records the resultant image. The edge of the shadow 106 would be observed at point B if the road surface 103 were flat, at point A if the road surface were convex, and at point C if the road surface were concave. The mathematical relationships existing for the height of a concave surface (a bump in the road), h₁, and that of a convex surface (a “pothole”), h₂, are:

h₁=d(tan θ−tan θ₁) (11)

h₂=d(tan θ−tan θ₂) (12)

where:

θ=the angle observed for the shadow edge by the imager 101 for a flat surface 103

θ₁=the angle observed for the shadow edge by the imager 101 for a “bump” 104

θ₂=the angle observed for the shadow edge by the imager 101 for a “pothole” 105

d=the distance between the shadow edge 106 and the imager 101 parallel to the direction of travel of the vehicle 110

These relationships allow profiling of the road surface 103 by simple mathematical manipulation of the digital data recorded by the imager 101. The sign convention provides positive values for convex irregularities 104 in the road surface 103 and negative values for concave irregularities 105.

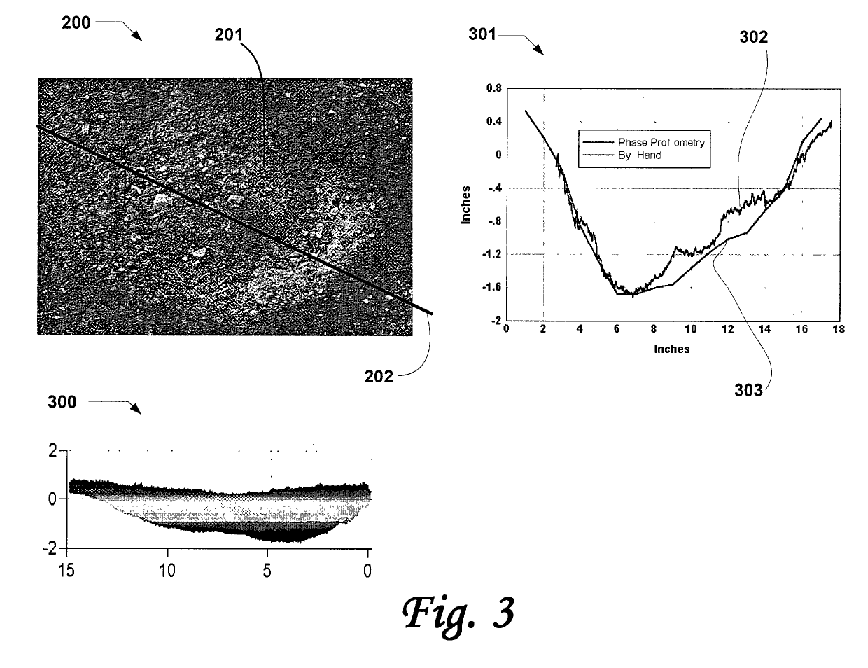

Refer to FIG. 3. The pothole 201 of FIG. 2 is depicted together with a mathematically derived vertical profile 300 of the pothole 201 acquired by employing phase profilometry as described above. Also shown is a graph 301 depicting a comparison of measurements taken in a vertically oriented plane through a centerline of the pothole using phase profilometry as shown at 302 and by hand as depicted at 303.

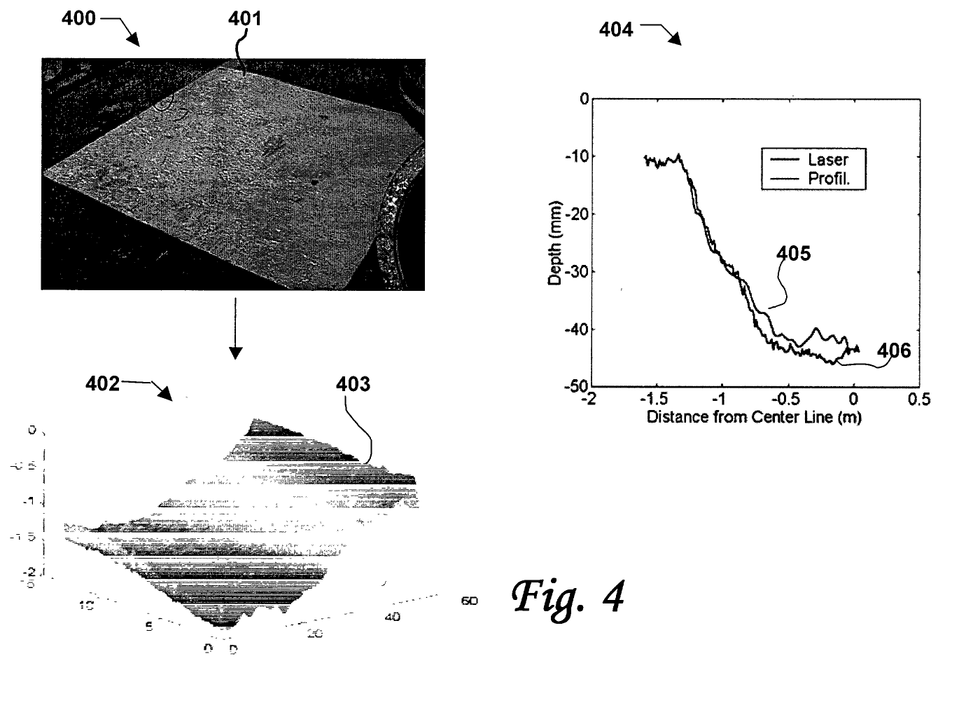

Refer to FIG. 4. A section of road surface 401 is selected from the road 400 for profiling. A three-dimensional mathematical representation 402 derived from phase profilometry measurements shows the raised portion 403 particularly well. Also depicted in a graph 404 of depth versus distance from the centerline of the section of road surface 401 are comparative measurements 405 from a phase profilometer of the present invention and measurements from a laser 406.

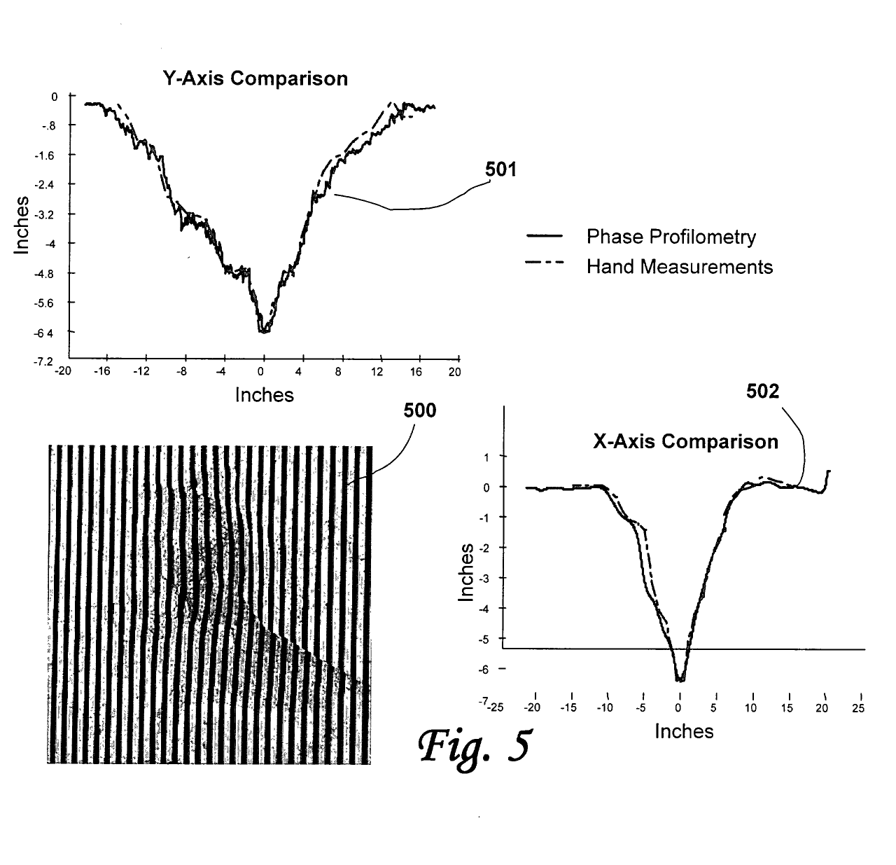

Refer to FIG. 5. A crater in a concrete runway is imaged as depicted at 500. A comparison of phase profilometry data with hand measurements taken along the y-axis over the depth of the crater is depicted at 501 while at 502, the same comparison is made for measurements taken along the x-axis of the crater, the depth being the z-axis. As seen, there is very close correlation, certainly sufficient for applications such as profiling a road surface or the bottom of a channel or harbor.

### EXAMPLE II

To support a pro-active suspension system on the vehicle 110, the profiling system need extend only in front of each tire 111. The individual pixels in the imager each measure an angle, θ, from the edge of the shadow and from this angle, a height or depth of the area being imaged by the pixel is determined. The data are stored in appropriate storage media and processed by digital signal processors (DSPs) as necessary. It is beneficial to use high speed processors in this application in order to afford the pro-active suspension sufficient time to adjust to the changes in road surface identified by the profiling system.

### EXAMPLE III

To perform road profiling for use in planning construction, ongoing maintenance, and similar routine engineering functions, the position of the vehicle on which the system is carried should be known with some specificity. Thus, additional sensors may include: a GPS system, a two-axis tiltmeter for recording vehicle attitude with respect to the vertical, and an electronic compass to record the direction of travel when the vehicle is stopped or moving too slowly to make beneficial use of GPS. For a parallel use of data obtained using phase profilometry and high speed processing implemented in software see, for example, U.S. Pat. No. 6,385,335 B1, Apparatus and Method for Estimating Background Tilt and Offset, to Rudd et al., May 7, 2002, incorporated herein by reference.

### EXAMPLE IV

To ascertain quickly and efficiently when and where maintenance may be required in an objective and quantifiable manner, one may use a preferred embodiment of the present invention to take data on a newly built or re-surfaced road and store it for future use. Taking additional data at pre-specified intervals after the road has been put into use, enables precise estimation of not only what needs maintenance but when it is needed. This “historic” information may be stored in a database for evaluation of the advantages of various types of road surfaces, expected life, lifecycle cost of a road surface, contractor performance, response to loading and weather, and other useful management information.

### EXAMPLE V

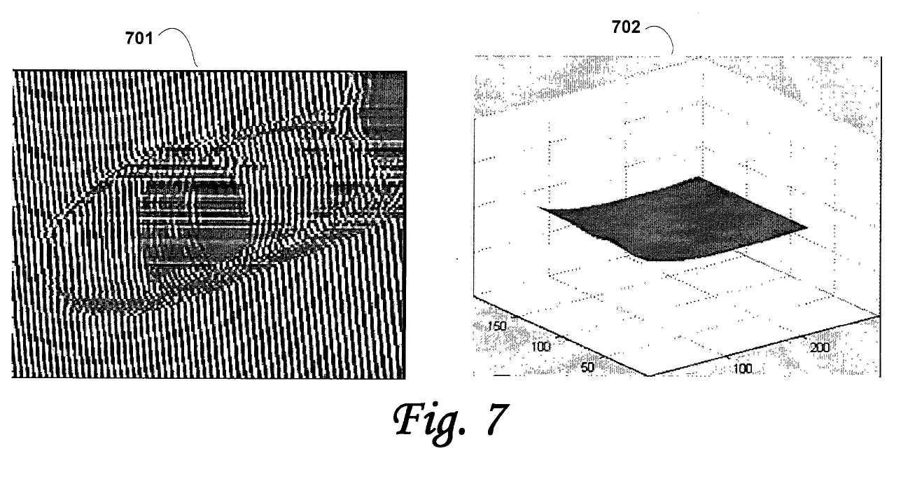

Refer to FIG. 7. An embodiment of the present invention, i.e., a fixed-geometry phase profilometry system having one illuminator, one imager and a processor with necessary control electronics for simple operation and data storage, was mounted on a HUMVEE® military vehicle and the vehicle operated normally over a road surface. Data were taken continuously of the road surface immediately in front of the vehicle as it was being driven. A representative depiction of the distortion introduced for purposes of ascertaining height is provided at 701 while the mathematically-derived 3-D depiction of a portion of the road surface is shown at 702. As can be seen, the data are suitable for translation into a form suitable for viewing by a decision maker, but the digitally processed data may be used without converting to a geometrical form, e.g., by “digitally comparing” updated data to a baseline that may have been recorded at initial surfacing or re-surfacing of the road.

### EXAMPLE VI

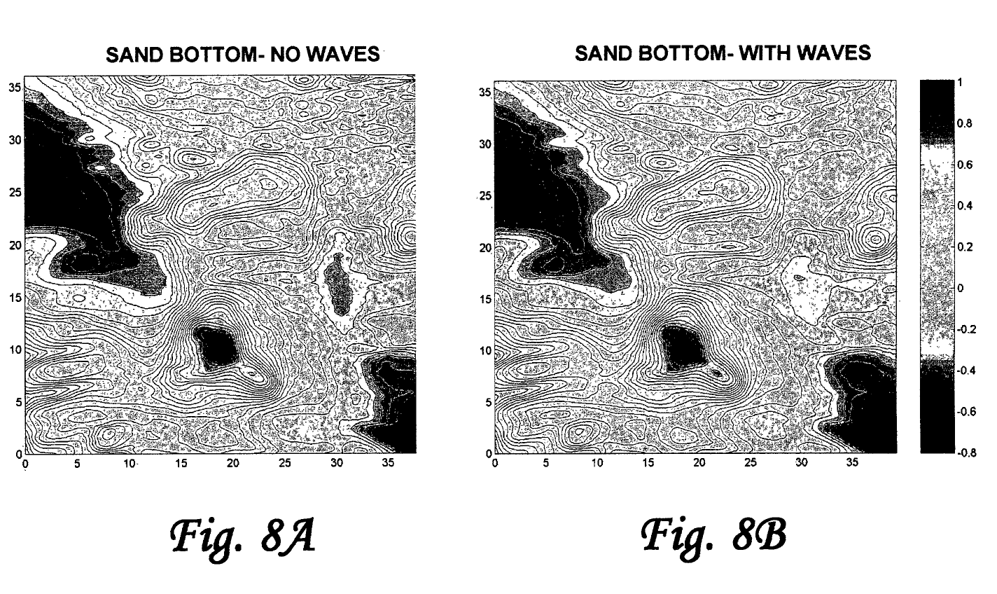

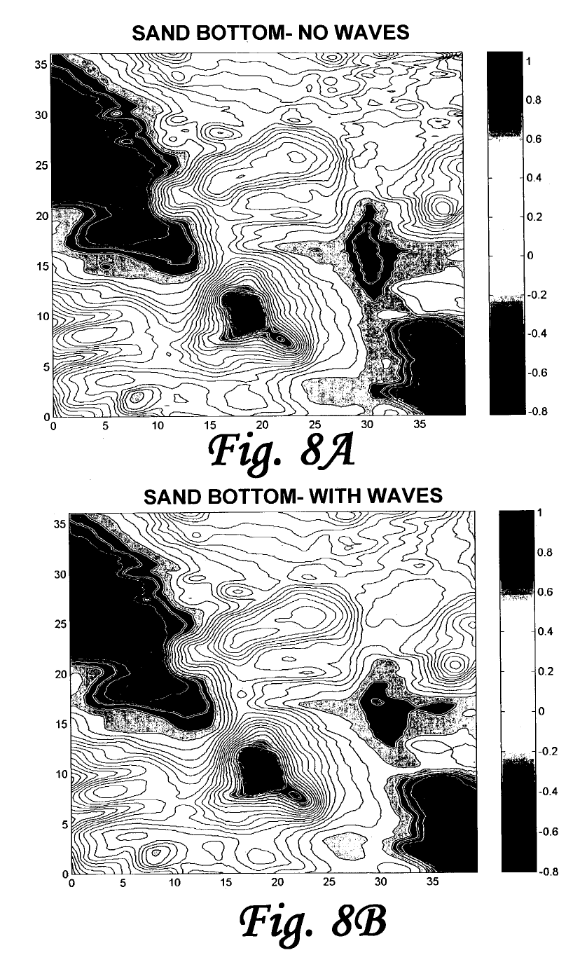

In addition to the use of phase, or more specifically shadow, profilometry for surfaces for which the view is through relatively clear air, it may be used to read the bottom of a body of water, given sufficient clarity of the water and reasonable depth of water. Refer to FIG. 8A in which the bottom topography of sand in a large hydraulic model has been derived using a preferred embodiment of the present invention. Refer to FIG. 8B in which the same bottom topography of sand of FIG. 8A is depicted as obtained during operation of a wave generator with the model. Thus, it can be seen that a preferred embodiment of the present invention is useful in realistic events such as exist along coastal regions and within harbors.

Although specific types of phase and shadow profilometry are discussed, other similar configurations or methods, including those that may have only some of the constituents or steps used in the above examples, may be suitable for identifying three dimensions of structure and thus fall within the ambit of a preferred embodiment of the present invention as provided in the claims herein.

We claim:

1. A method for determining a three dimensional profile of structure comprising:
employing a source of electromagnetic energy to project electromagnetic energy on said structure;
employing a device to direct said projected electromagnetic energy;
establishing at least one contrasting portion on said structure by utilizing projections from said source of electromagnetic energy as directed by said device;
providing a collector positioned off-axis from said source;
moving said at least one device over said structure in one direction at a time,
wherein, as seen by said collector, said projecting of said directed electromagnetic energy results in at least one distorted portion of reflections of said directed electromagnetic energy from said structure wherever said structure has a vertical component perpendicular to the plane parallel to the direction of movement of said at least one device;
using said at least one off-axis collector to collect said reflections from said structure;
providing at least one pre-specified algorithm; and
using said at least one pre-specified algorithm, processing said reflections,
wherein said processing yields at least one three dimensional profile of said structure.

2. The method of claim 1 in which said source operates at a wavelength selected from the group consisting of: visible electromagnetic waves of a single frequency, visible electromagnetic waves operating at multiple frequencies, invisible electromagnetic waves of a single frequency, invisible electromagnetic waves operating at multiple frequencies, and any combination thereof.

3. The method of claim 2 in which said wavelength is selected from the group consisting of: non-coherent visible light, non-coherent invisible light, non-coherent x-rays, non-coherent ultraviolet light, non-coherent infrared light, non-coherent radar waves, non-coherent radio waves, and combinations thereof.

4. The method of claim 2 in which said wavelength is selected from the group consisting of: coherent visible light, coherent invisible light, coherent x-rays, coherent ultraviolet light, coherent infrared light, coherent radar waves, coherent radio waves, and combinations thereof.

5. The method of claim 3 in which said contrasting portion is a shadow.

6. The method of claim 4 in which said contrasting portion is a shadow.

7. The method of claim 1 in which said at least one off-axis collector is a camera.

8. The method of claim 7 in which said camera is a digital camera.

9. The method of claim 1 in which said at least one device directs said source of electromagnetic energy partially blocked so as to cast at least one shadow on said structure,
wherein said at least one shadow impinges on a flat surface of said structure in the form of a continuous line and is distorted from said continuous line on a non-flat surface of said structure.

10. The method of claim 1 in which said at least one device directs said source of electromagnetic energy partially blocked so as to cast only one shadow on said structure,
wherein said shadow impinges on a flat surface of said structure in the form of a straight line and is distorted from said straight line on a non-flat surface of said structure.

11. The method of claim 9 in which said at least one shadow is presented non-parallel to the direction of movement of said device.

12. The method of claim 10 in which said one shadow is presented non-parallel to the direction of movement of said device.

13. The method of claim 9 in which said at least one shadow is presented parallel to the direction of movement of said device.

14. The method of claim 10 in which said one shadow is presented parallel to the direction of movement of said device.

15. The method of claim 9 in which said at least one shadow comprises multiple shadows each parallel one to the other.

16. The method of claim 1 in which said processing comprises:
converting any said collected reflections that are analog to digital format;
performing a Fast Fourier Transform (FFT) of said collected reflections as provided in digital format, to yield FFT data;
filtering said resultant FFT data about the fundamental spectral frequency of said directed electromagnetic energy in the direction transverse to the direction of movement of said device; and
employing said at least one complex algorithm to extract at least one change in phase, Δθ, of said directed electromagnetic energy.

17. The method of claim 16 wherein said AO is related to changes in said vertical component of the dimension of said structure, z, by the relationship:
$$z ( x , y ) = \frac{L \cdot Δ θ}{Δ θ - 2 π \cdot f \cdot d}$$
where:
f=instantaneous frequency of said electromagnetic energy
d=interplanar distance between said collector and said device where each are located in the same plane
L=distance between said collector and the top surface of said structure as represented by the instantaneous reflection of said directed electromagnetic energy
wherein after processing a single frame of said reflections, an ordered triplet (x, y, z) is established for concurrent use or archives, and
wherein multiple said ordered triplets may be used or displayed concurrently with employment of said method.

18. A system for determining a three dimensional profile of structure, comprising:
at least one device for directing electromagnetic energy in a pre-specified form to said structure,
wherein said at least one device is moved over said structure while maintaining physical separation therefrom, and
wherein said device enhances the contrast of said electromagnetic energy impinging on said structure;
at least one collector for acquiring electromagnetic energy reflected from said structure and providing said acquired electromagnetic energy as output, and
at least one processor, having an input and an output, in operable communication with said at least one collector for manipulating said output of said at least one collector.

19. The system of claim 18 as mounted on a conveyance.

20 The system of claim 18 in which said at least one device is a portion of a conveyance upon which said system is mounted.

21 The system of claim 18 in which said at least at least one processor provides an interface to at least one second system.

22 The system of claim 18 in which said at least at least one processor incorporates a control function for both collecting and processing said collected electromagnetic energy.

23 The system of claim 18 in which said at least one collector is at least one imager.

24 The system of claim 23 in which said at least one imager is a camera.

25 The system of claim 24 in which said camera is a digital camera.

26 The system of claim 18 further comprising a control separate from said at least one processor.

27 The system of claim 26 in which said control facilitates storing, manipulating, and reporting said output of said at least one processor.

28 The system of claim 18 in which said second system is a pro-active suspension on a conveyance that is carrying said system.

29 The system of claim 18 in which said electromagnetic energy is provided at a wavelength selected from the group consisting of: visible electromagnetic waves of a single frequency, visible electromagnetic waves operating at multiple frequencies, invisible electromagnetic waves of a single frequency, invisible electromagnetic waves operating at multiple frequencies, and any combination thereof.

30 The system of claim 18 in which said electromagnetic energy is provided as light in a form selected from the group consisting of: non-coherent visible light, non-coherent infrared (IR) light, non-coherent ultraviolet (UV) light, coherent visible light, coherent infrared (IR) light, coherent ultraviolet (UV) light, and any combination thereof.

31 The system of claim 18 further comprising at least one tiltmeter for inputting information on the attitude of said system.

32 The system of claim 18 further comprising at least one GPS receiver for inputting information on the location of said system.

33 The system of claim 18 further comprising at least one source of electromagnetic energy.

34 The system of claim 33 in which said at least one source provides light of a type selected from the group consisting of: non-coherent visible light, non-coherent invisible light, non-coherent infrared (IR) light, non-coherent ultraviolet (UV) light, coherent visible light, coherent infrared (IR) light, coherent ultraviolet (UV) light), and any combination thereof.

35 A system that facilitates planning of the construction and maintenance of structure and contract oversight thereof, comprising:
at least one device for directing electromagnetic energy in a pre-specified form to said structure,
wherein said at least one device is moved over said structure while maintaining physical separation therefrom, and
wherein said device enhances the contrast of said electromagnetic energy impinging on said structure;
at least one collector for acquiring electromagnetic energy reflected from said structure and providing said acquired electromagnetic energy as output, and
at least one processor, having an input and an output, in operable communication with said at least one collector for manipulating said output of said at least one collector; and
at least one controller that facilitates storing, manipulating, and reporting said output of said processor,
wherein said system is mounted on a conveyance.

36. A system that facilitates the conduct of large scale modeling of the surface of structure, comprising:
at least one device for directing electromagnetic energy in a pre-specified form to said structure,
wherein said at least one device is moved over said structure while maintaining physical separation therefrom, and
wherein said device enhances the contrast of said electromagnetic energy impinging on said structure;
at least one collector for acquiring electromagnetic energy reflected from said structure and providing said acquired electromagnetic energy as output, and
at least one processor, having an input and an output, in operable communication with said at least one collector for manipulating said output of said at least one collector; and
at least one controller that facilitates storing, manipulating, and reporting said output of said processor,
wherein said system is mounted on a conveyance.
